(19) United States
(12) Patent Application Publication
(10) Pub. No.: US 2023/0063279 A1
(43) Pub. Date: Mar. 2, 2023

(54) OSCILLATING TRAVERSE COILER

(71) Applicant: Reel Power Licensing Corp., Oklahoma City, OK (US)

(72) Inventors: Michael J. Boothe, Oklahoma City, OK (US); David Lasswell, Oklahoma City, OK (US); Joseph Crosley, Oklahoma City, OK (US); Joseph Henry, Oklahoma City, OK (US)

(21) Appl. No.: 17/895,509

(22) Filed: Aug. 25, 2022

Related U.S. Application Data
(60) Provisional application No. 63/240,028, filed on Sep. 2, 2021.

(51) Int. Cl. B65H 54/28; B65H 75/14; B65H 57/26; B65H 57/16

(52) U.S. Cl. CPC B65H 54/2803; B65H 75/14; B65H 57/26; B65H 57/16; B65H 2701/33; B65H 2701/32

(57) ABSTRACT

The present invention is an oscillating traverse coiler for flexible elongated materials apparatus, system, and method for use. The invention may include a reel having a first flange, a second flange, and a barrel between. The invention may include a take-up machine having a computer control that works in communication with a positioning system, which may include a frame, guide rails that traverse the frame with a motor, a computer controller, and a rotating materials guide for rotating pipe flexible elongated materials on the barrel of a reel.

### CROSS-REFERENCE TO RELATED APPLICATIONS

This application claims priority from U.S. Provisional Patent Application Ser. No. 63/240,028 filed on Sep. 2, 2021, currently pending, and is expressly incorporated herein by reference in its entirety.

### BACKGROUND OF INVENTION

### 1. Field of the Invention

In general, the present invention relates to coiling pipe, hose, tube, fiber optics cables, and so forth on a reel. More particularly, the present invention provides a new device, system, and method of coiling wherein multiple pieces of material to be coiled may be precisely laid in a specific desired order on the reel by utilizing an oscillating traverse coiler.

### 2. Description of the Prior Art

It is known in construction to run flexible conduit pipe, hose, tube, fiber optic cables, and so forth, herein after referred to pipe, simultaneously from a reel that might hold different types and numbers of pipes. Typically, these pipes are made in different diameters and from materials such as but not limited to polyethylene. It is also known that pipes utilized in construction are color coded for indicating different utilities such as gas, hot water, cold water, wastewater, vacuum, air, and so forth. By example, it is desirable in construction, to run a colored cold-water line and a different colored hot water line at the same time for convenience and consistency. It is also desirable to have the leading color pipe to always be out in front on the reel.

In the prior art, to attain the objection of the location of the different color-coded pipes on the reel, extensive manual labor is required to move the pipes onto the reel in the desired locations. This is time consuming and hard work that may lead to injuries.

The current state of the art automatic coilers clearly have room for improvement and attempts at improvements to the associated deficiencies have not provided the desired solutions. Thus, there is a need for an apparatus, process, and or system that provides a coiling system to precisely wind different pipes of different colors onto a reel for later dispensing the pipes when being utilized for placement. The above discussed limitations in the prior art is not exhaustive. The current invention provides an inexpensive, time saving, more reliable apparatus, method, and system for use with a coiler where the prior art fails.

### SUMMARY OF THE INVENTION

In view of the foregoing disadvantages inherent in the known types of coiling systems now present in the prior art, the present invention provides a new and improved apparatus, system, and method of using. As such, the general purpose of the present invention, which will be described subsequently in greater detail, is to provide a new automatic coiler system, which has all the advantages of the prior art devices and none and or fewer of the disadvantages.

It is, therefore, contemplated that the present invention is an oscillating traverse coiler for flexible elongated materials apparatus, system, and method for use. The invention may generally include a reel having a first flange, a second flange, and a barrel between. The invention may include a take-up machine having a computer control that works in communication with a positioning system, which may include a frame, guide rails that traverse the frame with a motor, a computer controller, and a rotating materials guide for rotating pipe flexible elongated materials on the barrel of a reel.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Therefore, it is an object of the present invention to provide a new and improved automatic coiler for use to coil materials on a reel with precision orientation without manual labor thereby reducing labor.

Furthermore, an object of the present invention is to provide a new and improved automatic coiler apparatus, system, and method that automatically follows the speed of the take up.

Another object of the present invention is to provide a new and improved automatic coiler, which allows the materials to be coiled and keeps the same-colored pipe on the leading edge while the layers of material wind onto the reel

It is a further object of the present invention to provide a new and improved automatic coiler apparatus, system, and method, which is of a durable and reliable construction.

An even further object of the present invention is to provide a new and improved automatic coiler apparatus, system, and method, which is susceptible to a low cost of installation and labor, which accordingly is then susceptible to low prices of sale to the consuming industry, thereby making such a system economically available to those in the industry.

Still another object of the present invention is to provide a new and improved automatic coiler apparatus, system, and method, which provides all of the advantages of the prior art while simultaneously overcoming some of the disadvantages normally associated therewith.

Yet still another object of the present invention is to provide a new and improved automatic coiler that is more ergonomic by removing the human element thereby increasing safety.

These, together with other objects of the invention, along with the various features of novelty, which characterize the invention, are pointed out with particularity in the claims annexed to and forming a part of this disclosure. For a better understanding of the invention, its operating advantages, and the specific objects attained by its uses, reference should be had to the accompanying drawings and descriptive matter in which there are illustrated preferred embodiments of the invention.

### BRIEF DESCRIPTION OF THE PICTORIAL ILLUSTRATIONS, GRAPHS, DRAWINGS, AND APPENDICES

The invention will be better understood and objects other than those set forth above will become apparent when consideration is given to the following detailed description thereof. Such description makes reference to the annexed pictorial illustrations, graphs, drawings, and appendices.

FIG. 1 is generally an illustration in accordance with a preferred embodiment of the invention at a start position before rotation.

FIG. 2 is generally an illustration in accordance with a preferred embodiment of the invention at a start position before rotation.

FIG. 3 is generally an illustration in accordance with a preferred embodiment of the invention at a start position before rotation.

FIG. 4 is generally an illustration in accordance with a preferred embodiment of the invention at a start position before rotation.

FIG. 5 is generally an illustration in accordance with a preferred embodiment of the invention at a start position before rotation.

FIG. 6A is generally an illustration in accordance with a preferred embodiment of the invention before rotation.

FIG. 6B is generally an illustration in accordance with a preferred embodiment of the invention starting rotation.

FIG. 6C is generally an illustration in accordance with a preferred embodiment of the invention rotated 180 degrees.

FIG. 7 is generally an illustration in accordance with a preferred embodiment of the invention.

### DETAILED DESCRIPTION OF INVENTION

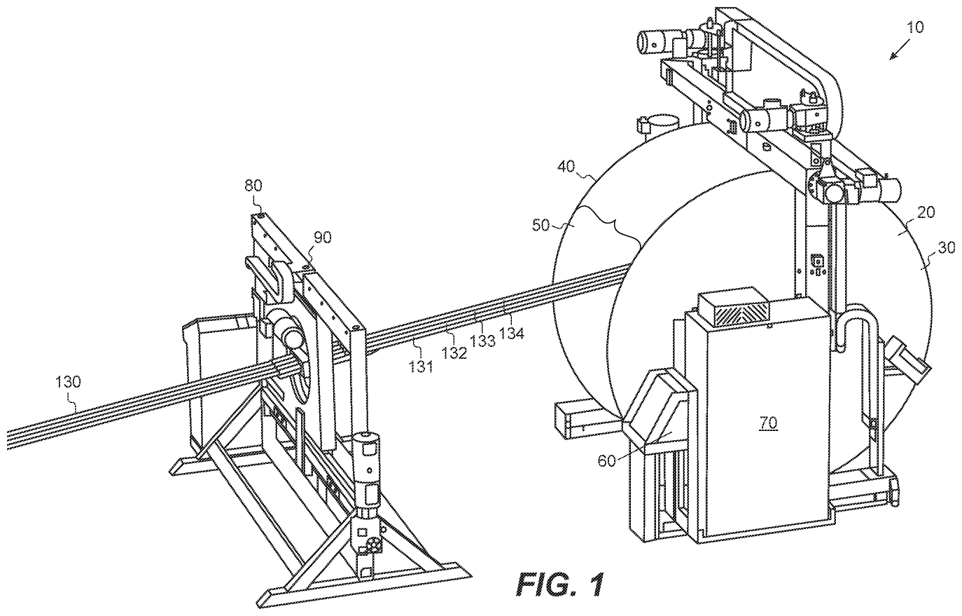

Referring to the illustrations, drawings, and pictures, and to FIG. 1 in particular, reference character 10 generally designates a new and improved automatic coiler apparatus, system, and method of using same constructed in accordance with the present invention. For purposes of convenience, the reference numeral 10 may generally be utilized for the indication of the invention, portion of the invention, preferred embodiments of the invention and so on. Invention 10 is generally used in coiling but is not limited to the material being coiled such as coiling pipe, hose, tube, and so forth.

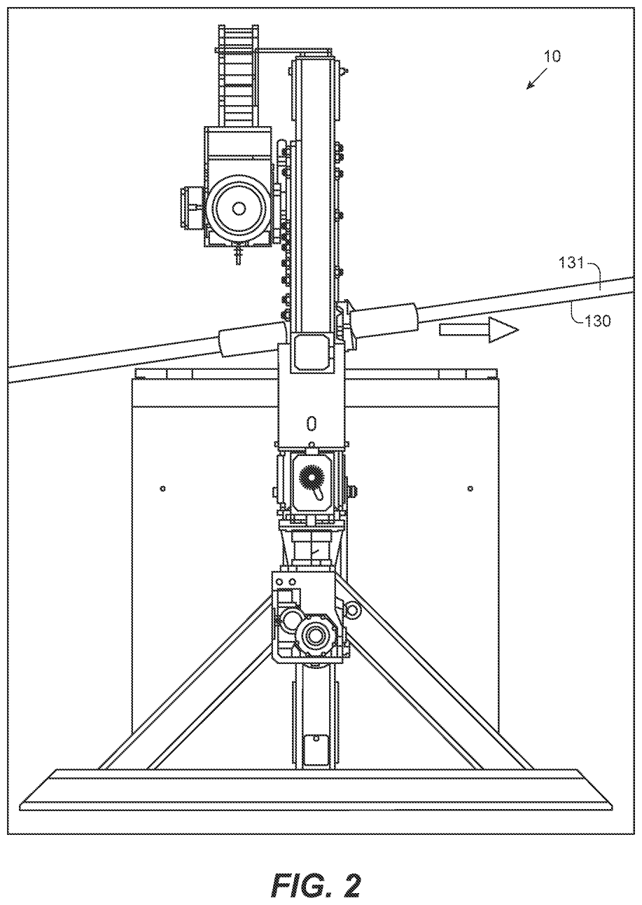

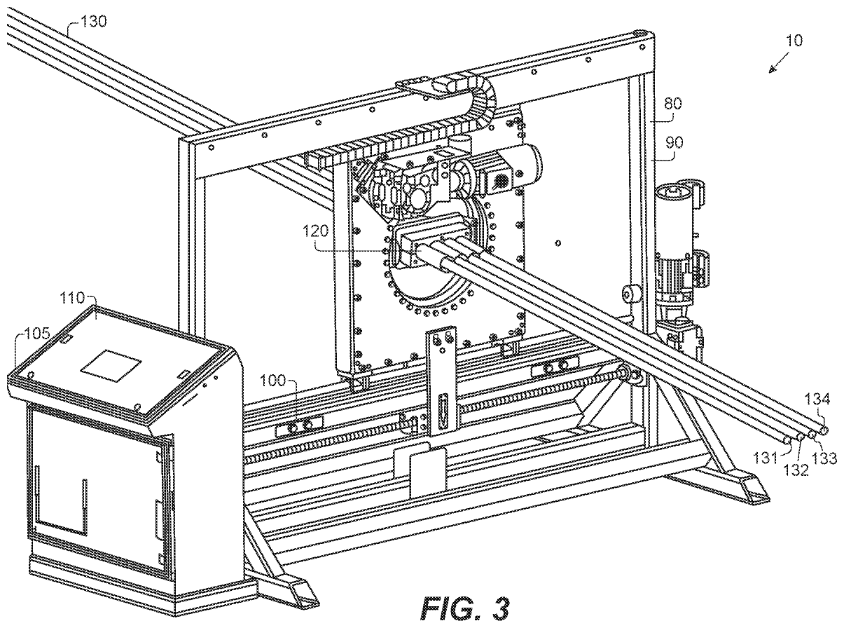

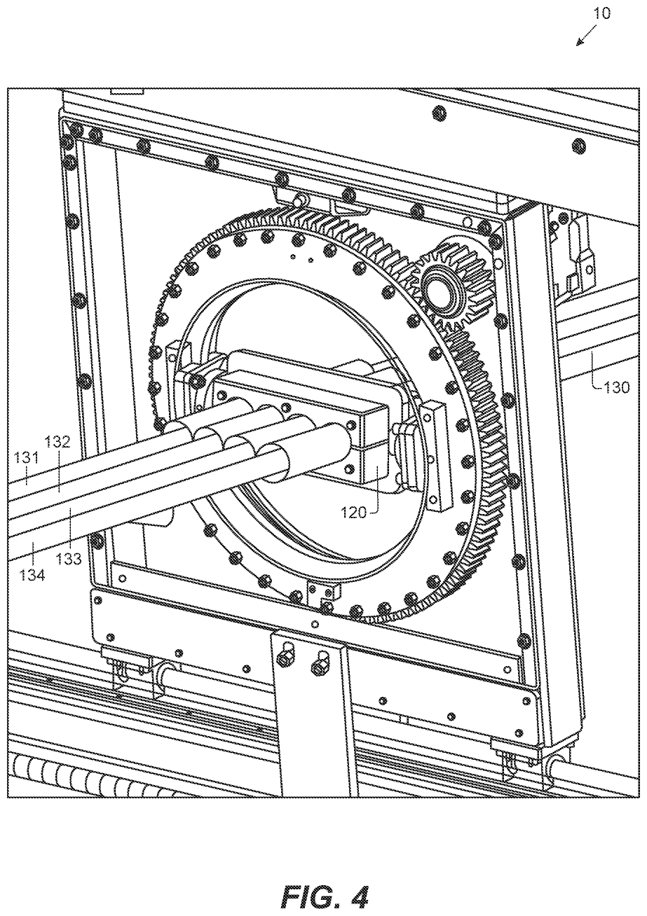

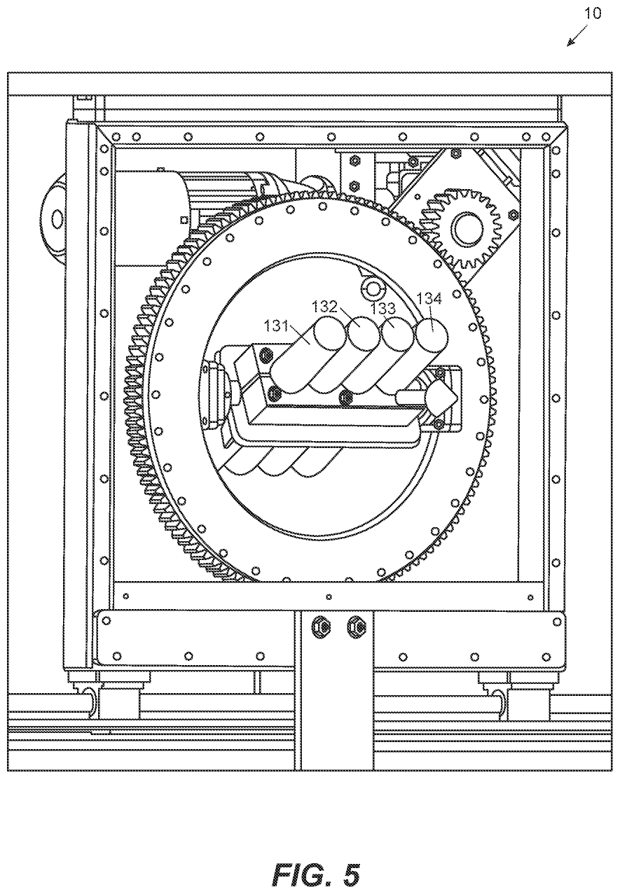

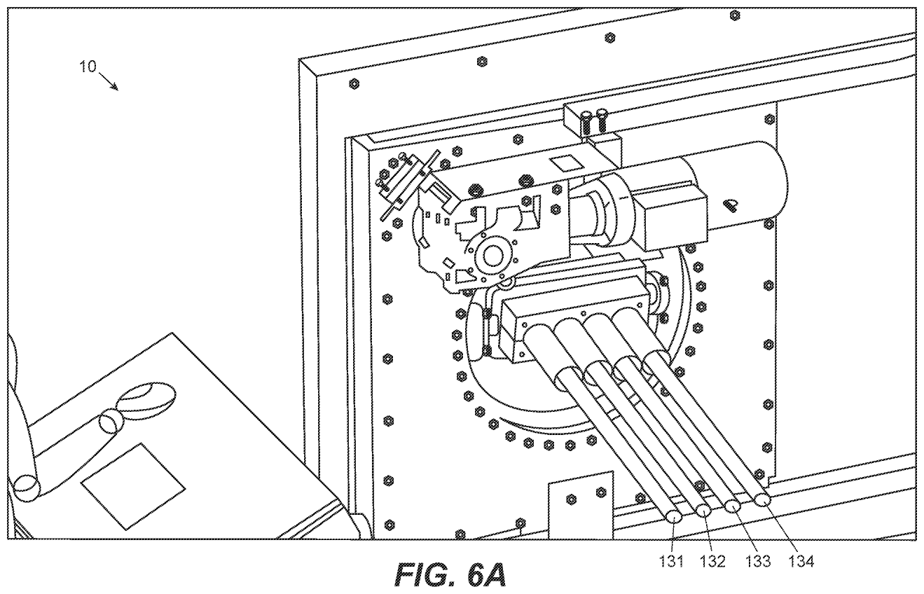

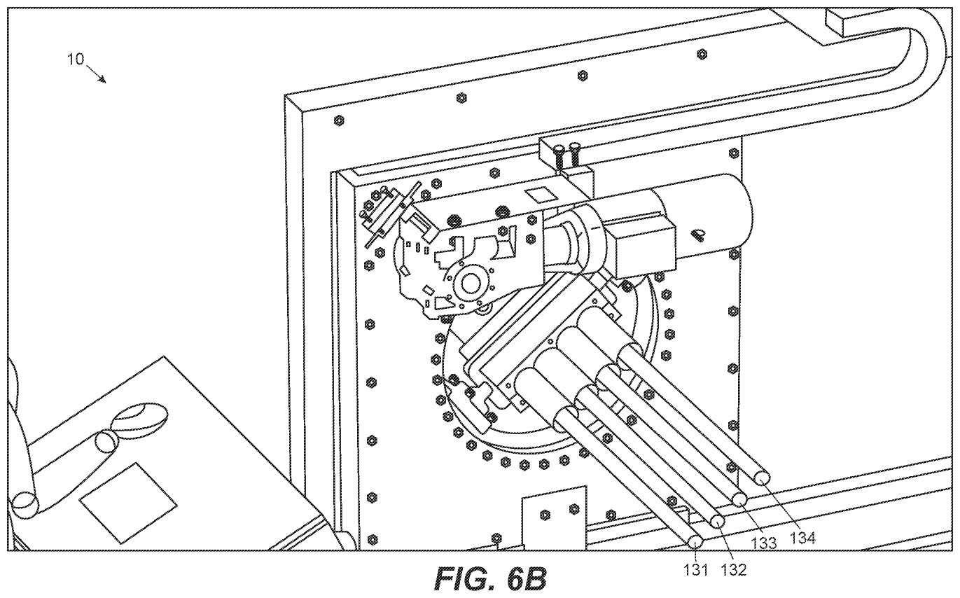

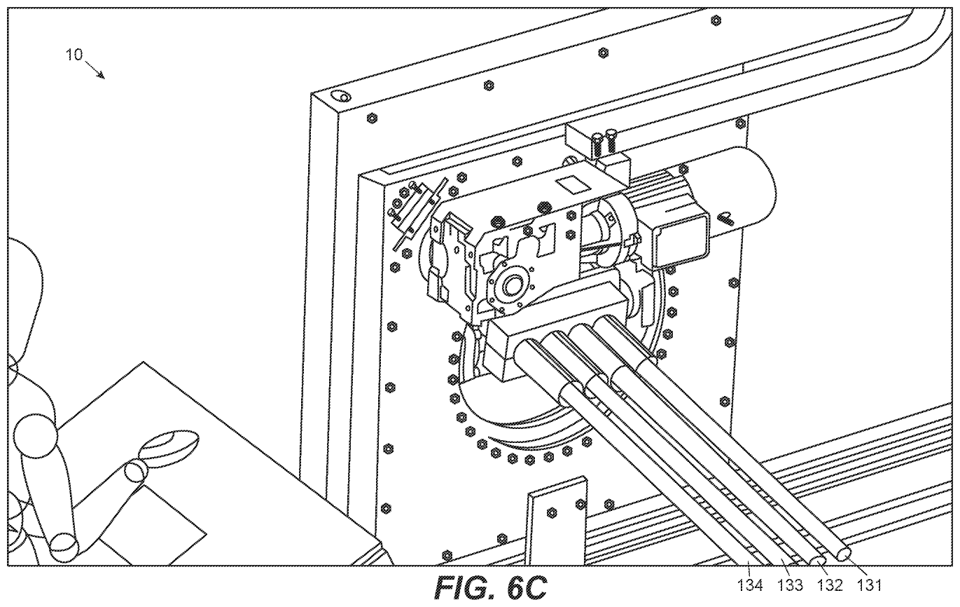

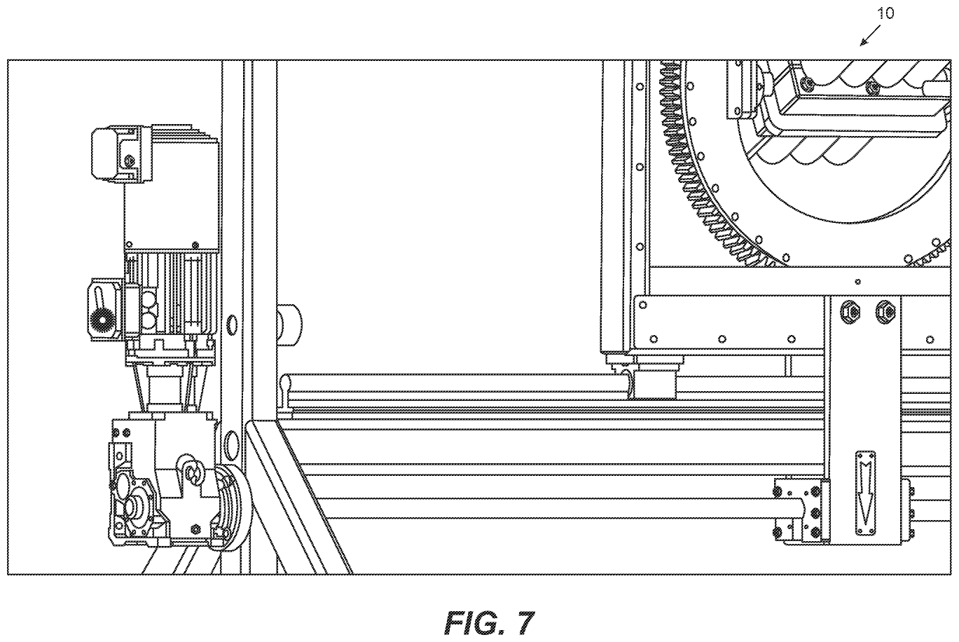

Now referring to the FIGS. 1-5, 6A-6C, and 7, invention 10 may generally include a reel 20 having a first flange 30, a second flange 40, and a barrel 50 between. The invention 10 may include a take-up machine 60 having a computer control 70.

Positioning system 80 may include a frame 90, guide rails 100 that traverse the frame 90 with a motor 105, a computer controller 110, and a rotating materials guide 120 for rotating collectively pipes and or pipe 130. The term “pipe” may include but is not limited to elongated flexible materials such as inflexible conduit pipe, hose, tube, fiber optic cables, and so forth, herein after referred to collectively as pipe 130.

It is understood that it is desirable to wind, coil, and or stack similar pipe 130 on barrel 50 for unwinding purposes. By example, but not to be considered limiting, pipe 130 may be several varieties of purposed pipe 130 such as pipe 131, pipe 132, pipe 133, pipe 134, and so forth.

It is therefore contemplated that invention 10 may be a coiling system for coiling pipes on a reel having a first flange, a second flange, and a barrel between said first flange, said second flange, and a computer controller for selectively rotating said barrel comprising: a positioning system for selectively positioning said pipes on said barrel having a rotating guide for selectively positioning said pipes on said barrel, a computer controller adapted to provide said positioning system to selectively traverse said barrel for allowing said positioning system to selectively coil said pipes on said barrel, and wherein said rotating guide is adapted to rotate 180 degrees clockwise and counterclockwise.

Changes may be made in the combinations, operations, and arrangements of the various parts and elements described herein without departing from the spirit and scope of the invention. Furthermore, names, titles, headings, and general division of the aforementioned are provided for convenience and therefore, should not be considered limiting.

What is claimed is:

1. A coiling system for coiling pipes on a reel having a first flange, a second flange, and a barrel between said first flange, said second flange, and a computer controller for selectively rotating said barrel comprising:
a positioning system for selectively positioning said pipes on said barrel having a rotating guide for selectively positioning said pipes on said barrel, a computer controller adapted to provide said positioning system to selectively traverse said barrel for allowing said positioning system to selectively coil said pipes on said barrel, and wherein said rotating guide is adapted to rotate 180 degrees clockwise and counterclockwise.
